(19) United States
(12) Patent Application Publication
(10) Pub. No.: US 2012/0084197 A1
(43) Pub. Date: Apr. 5, 2012

(54) Managing Credit Risk

(75) Inventors: Frank PETRALITO, Mooresville, NC (US); William A. NOBILI, Charlotte, NC (US); Arun R. PINTO, Charlotte, NC (US); John MIHM, Charlotte, NC (US)

(73) Assignee: BANK OF AMERICA CORPORATION, Charlotte, NC (US)

(21) Appl. No.: 12/897,356

(22) Filed: Oct. 4, 2010

(51) Int. Cl. G06Q 40/00

(52) U.S. Cl. 705/38

(57) ABSTRACT

Aspects of this disclosure relate to a computer assisted method for managing credit risk which includes electronically receiving data regarding one or more credit quality standards, electronically receiving data regarding one or more policy limits or exception rate limits and electronically receiving data regarding one or more concentration limits. The method may further include using a computer to establish one or more predetermined delinquency guardrails which relate to a maximum desired potential Net Credit Losses (NCL) or a minimum desired potential return (e.g., Risk Adjusted Margin (RAM)) for particular aspects of an organization. The method may further include managing a credit risk by making a series of determinations about the electronically received data, wherein the determinations may include at least one of: determining whether the one or more predetermined delinquency guardrails have been exceeded, determining whether the policy limits or exception rate limits have been exceeded, and determining whether the concentration limits have been exceeded.

### FIELD OF DISCLOSURE

Aspects of the present disclosure relate generally to managing credit risk. Particular aspects of the present disclosure relate to managing credit risk for new originations. Further, particular aspects of the present disclosure relate to managing credit risk for a portfolio.

### BACKGROUND

A common objective of many businesses is to manage the risk associated with credit the business may extend to its customers. For example, a bank may have one or more consumer products, through which it extends credit to its customers. Such consumer credit products may include credit cards, home loans (e.g., first mortgages), home equity lines of credit (HELOCs), auto loans, specialty loans (e.g., loans for boats or recreational vehicles), small business loans, etc. There is a risk associated with such consumer credit products wherein the borrower may not pay back some or all of the money, or funds, loaned through the consumer credit product. It would be advantageous for the business to have a method and/or system which manages credit risks, such as the credit risk associated with consumer credit products, in order to effectively and efficiently limit the potential risk while still allowing for potential gains for the business due to the credit products.

### SUMMARY

Therefore, aspects of the disclosure relate to a system and method for managing credit risk. Particular aspects of the present disclosure relate to managing credit risk for consumer credit products. Further, aspects of the present disclosure may be applied to commercial products if desired. Particular aspects of the present disclosure relate to managing credit risk for new originations. Further, aspects of the present disclosure may relate to managing credit risk for a portfolio.

Aspects of the disclosure may relate to a method for managing credit risk which may include receiving data regarding one or more credit quality standards, receiving data regarding one or more policy limits or exception rate limits, and receiving data regarding one or more concentration limits. The method may further include establishing one or more predetermined delinquency guardrails which relate to a maximum desired potential Net Credit Loss (NCL) or a minimum desired potential return (e.g., Risk Adjusted Margin (RAM)) for particular aspects of an organization. The method may further include managing a credit risk by making a series of determinations about the received data, wherein the determinations may include at least one of: determining whether the one or more predetermined delinquency guardrails have been exceeded, determining whether the policy limits or exception rate limits have been exceeded, and determining whether the concentration limits have been exceeded. The method may further include managing a credit risk which may include taking a corrective action if one of the predetermined delinquency guardrails, policy limits, exception rate limits or concentration limits has been exceeded.

Further aspects of the disclosure may relate to a computer assisted method for managing credit risk which includes electronically receiving data regarding one or more credit quality standards, electronically receiving data regarding one or more policy limits or exception rate limits, electronically receiving data regarding one or more concentration limits. The method may further include using a computer to establish one or more predetermined delinquency guardrails which relate to a maximum desired potential Net Credit Loss (NCL) or a minimum desired potential return (e.g., RAM) for particular aspects of an organization. The method may further include managing a credit risk by making a series of determinations about the electronically received data, wherein the determinations may include at least one of: determining whether the one or more predetermined delinquency guardrails have been exceeded, determining whether the policy limits or exception rate limits have been exceeded, and determining whether the concentration limits have been exceeded. The method may further include managing a credit risk which may include taking a corrective action if one of the predetermined delinquency guardrails, policy limits, exception rate limits or concentration limits has been exceeded.

Additional aspects of the disclosure relate to a computer configured to manage credit risk which may include a processor and memory storing computer executable instructions that, when executed, may cause the computer to perform a method for managing credit risk, by: electronically receiving data regarding one or more credit quality standards, electronically receiving data regarding one or more policy limits or exception rate limits and electronically receiving data regarding one or more concentration limits. The method may further include establishing one or more predetermined delinquency guardrails which relate to a maximum desired potential Net Credit Loss (NCL) or a minimum desired potential return (e.g., RAM) for particular aspects of an organization. The method may further include, based on the electronically received data, determining at least one of: whether the one or more predetermined delinquency guardrails have been exceeded, whether the policy limits or exception rate limits have been exceeded, and whether the concentration limits have been exceeded. The method may further include managing a credit risk by taking a corrective action if one of the predetermined delinquency guardrails, policy limits, exception rate limits or concentration limits has been exceeded.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 illustrates a block diagram of a computing environment in which certain aspects of the present disclosure may be implemented; and

FIG. 3 shows a flow chart of an illustrative process for managing credit according to one or more aspects of the disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

As described above, a business may extend credit to its customers through various consumer products, such as credit cards, home loans (e.g., first mortgages), HELOCs, auto loans, specialty loans, small business loans, etc. or various commercial loans. Further, as described above, there is a risk associated with such credit products wherein a borrower might not pay back some or all of the funds loaned. Therefore, aspects of this disclosure are directed to systems and methods for managing credit risks, such as the risk associated with consumer credit products. Further, aspects of this disclosure are directed to systems and methods for managing credit risks in order to effectively and efficiently limit the potential risk while still allowing for potential gains for the business due to the credit products. As will be discussed below, by using such systems and methods described in the disclosure to manage risk associated with credit products, the business may be able to indentify and control the risk through disciplined and deliberate decisions to achieve its strategic goals. It is noted that throughout the disclosure, the term bank may be used interchangeably with business, financial institution, organization, etc. The term bank is not intended to be limiting, but rather merely describe a potential embodiment of the disclosure.

Aspects of the disclosure relate to three elements, Credit Quality (CQ) standards, policy limits and concentration targets or limits, each of which may contribute to managing credit risk. According to aspects of the disclosure, establishing and managing Credit Quality (CQ) standards, establishing and managing policy limits and establishing and managing concentration limits may each play a role in effectively and efficiently managing credit risk. Each of these three elements is described in detail below, however, it is noted that according to particular aspects of the disclosure, establishing and managing each of these elements may offer a holistic overview of the credit risk associated with the business and thereby allow the business to effectively and efficiently manage credit risk. For example, as discussed below, different portions of these three elements may be monitored and, further, the actions and strategies of the business may be potentially modified based on the results of the monitoring. For example, a business may regularly review and manage new originations and/or the portfolio against each of the CQ standards, policy limits and concentration targets and limits.

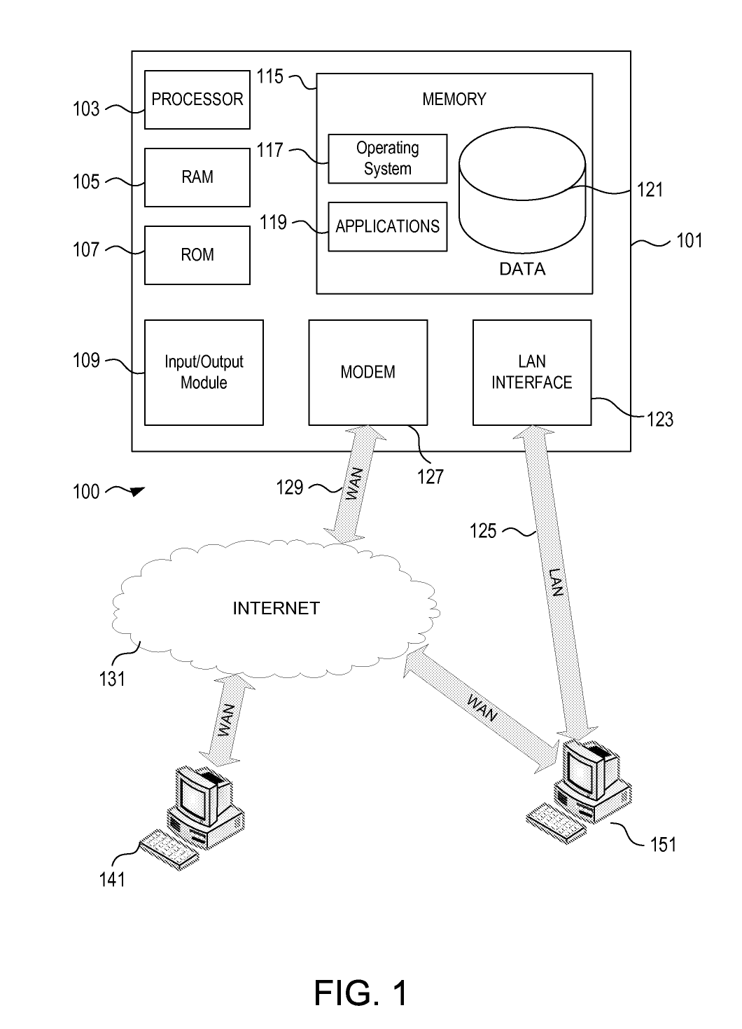

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

As discussed above, according to aspects of the disclosure, CQ standards may be one element that is monitored, managed and controlled in order to manage the credit risk associated with a business. According to aspects of the disclosure, CQ standards may be standards and limits which define risk and return standards for new originations of credit products. For example, according to aspects of the disclosure, the CQ standards may be defined to provide a maximum level of Net Credit Losses (NCL) and a minimum acceptable rate of return (e.g., a Risk Adjusted Margin (RAM) threshold) for new originations of credit products. Further, according to aspects of the disclosure, CQ acquisition standards may set to ensure portfolios are below a maximum NCL standard and above a minimum return (e.g., RAM) standard.

These levels of NCL and RAM may be set according to the particular business, its strategic goals, the particular credit product, etc. For example, with regard to a credit card account, a particular CQ standard may be set which includes a maximum level of NCL for a particular book of business (e.g., the number of new credit card accounts opened, or originations, over a particular period of time (e.g., a month)). For example, according to a particular embodiment of the disclosure, a maximum level of NCL may be 6.25% for the credit card accounts that the business originated in the month of January. Therefore, in order to meet the business objective, less than 6.25% of the credit card accounts that the business originated in the month of January should be charged off as a loss.

However, it is noted that when dealing with credit, it may take a relatively lengthy period of time in order to realize a loss. For example, with a credit card account, a borrower is given a predetermined amount of time to pay back any funds borrowed. Further, a borrower who does not pay back the funds with the predetermined amount of time may be charged late fees and given additional time to pay (e.g., 30 days past due, 60 days past due, 90 days past due, etc.). Therefore, it is understood, that with credit card accounts, it may take months (e.g., 10-12 months) before an account is charged off and realized as a loss. Additionally, with other credit products (e.g., first mortgages, etc.), it may take even longer (e.g., 18-24 months) before an account is charged off and realized as a loss.

However, a business may want to determine such potential risk much earlier than the amount of time it takes to realize a loss. If the business can determine such potential risk earlier, the business may be able to take appropriate corrective action earlier. For example, the business may alter its underwriting strategy before the loss is realized and, thereby, limit the risk associated with the potential losses of new originations. In this way, the business can potentially avoid further loss in the future.

Hence, given the length of time it takes to realize a loss, aspects of the disclosure are directed to indicators which may provide earlier detection of risk of loss for credit products. For example, according to aspects of the disclosure, delinquency guardrails may be established and analyzed in order to determine and monitor credit risk. A delinquency guardrail may be a standard that is analyzed in order to determine if a particular credit product poses a significant risk before the loss is actually realized. In this way, the business may use such information to alter its originations of new credit products in the future in order to limit such credit risks.

An example of this process and delinquency guard rails will be described with regard to credit cards. As discussed above, if a borrower does not pay back the funds borrowed through a credit card account, the account will go past due. For example, the account may go 30 days past due, 60 days past due, 90 days past due, etc. According to aspects of the disclosure, this information may be determined, analyzed and leveraged in order to indicate a potential risk with regard to a particular business practice. For example, as discussed above, according to aspects of the disclosure, a NCL standard may be set such that no more than 6.25% of the credit card accounts for a particular book of business are charged off as a loss. Hence, delinquency guardrails may be determined and set at certain time periods, which will indicate whether the business is on track to meet such a 6.25% NCL standard. For example, a delinquency guardrail may be set such that no more than a maximum of 0.09% of the credit card accounts for the particular book of business are delinquent at three months after origination. Therefore, according to aspects of the disclosure, the business may retrieve and analyze data from the credit card accounts and determine how many of the credit card accounts for the particular book of business are delinquent at three months after origination. If more than 0.09% of the credit card accounts for the particular book of business are delinquent at three months after origination, then the business may determine it is likely that more than 6.25% of the credit card accounts will be charged off as a loss. Hence, the business may alter its underwriting strategy to increase the strictness of its standards for its new credit card originations in the future (e.g., higher FICO® scores, longer credit history, etc.).

Other delinquency guardrails may be used as well. For example, a delinquency guardrail may be set such that no more than a maximum of 2.60% of the credit card accounts for the particular book of business are delinquent at six months after origination. Further, a delinquency guardrail may be set such that no more than a maximum of 3.70% of the credit card accounts for the particular book of business are delinquent at nine months after origination. Additionally, a delinquency guardrail may be set such that no more than a maximum of 4.80% of the credit card accounts for the particular book of business are delinquent at twelve months after origination. By using such delinquency guardrails as “early warning” indicators, the business may leverage such information to alter its originations of new credit products in the future in order to limit such credit risks. It is noted that the above examples of delinquency guardrails and the process with regard to credit cards is merely illustrative and not meant to be limiting. Other delinquency guardrails (particularly with regard to other credit products) and the process may be modified to incorporate other predictive or reactive behavior.

According to aspects of the disclosure, the CQ standards may be defined to provide a minimum acceptable return (e.g., RAM) threshold for new originations of credit products. According to particular aspects of the disclosure, the RAM may be considered as the total loan revenue generated from the credit products less the credit losses as a percentage of the average managed loans. The RAM may be set according to the particular business, its strategic goals, the particular credit product, etc. Further, if the CQ standard of the RAM is not being met then, similarly to the above described process for NCL, the business may use such information to alter their originations of new credit products in the future in order to increase the RAM in the future (e.g., relax the strictness of its standards for its new credit card originations in the future, such as lower FICO® scores being acceptable, less credit history, etc.).

According to aspects of the disclosure, and as will be described in detail below, the CQ information may be monitored periodically or routinely (e.g., the CQ information may be monitored monthly, quarterly, for each new book of business, etc.). For example, as will be described in detail below, according to aspects of the disclosure, information related to new originations or the portfolio may be stored in one or more databases of the business. Further, according to aspects of the disclosure, the business may have one or more computer systems configured to extract from the database selective information (such as described above) regarding the new originations or the portfolio and compile such information (such as described above) for the review by the business (e.g., a risk management team). According to aspects of the disclosure, the one or more computer systems configured to extract such information from the one or more databases may be configured to automatically extract and compile such information (e.g., periodically as described above). Further, according to aspects of the disclosure, the one or more computer systems may be configured to automatically indicate if a CQ standard is breached or about to be breached. In this way, the business may effectively and efficiently realize the potential risk associated with the circumstance and, hence, take action to manage (and limit) its credit risk. For example, the business may alter their new originations, manage their current assets (e.g., sell current assets or acquire new assets), change its underwriting strategy, etc. to correct the new originations or the portfolio to meet the CQ standard.

As discussed above, according to aspects of the disclosure, policy limits may be one element that is monitored, managed and controlled in order to manage the credit risk associated with a business. According to aspects of the disclosure, policy limits may be limits on the amount of business an organization may do with regard to a particular area or aspect of business. For example, a policy limit may define a particular area or aspect of business wherein the business will not extend new credit. The rationale for imposing the limit on a particular aspect of business may be based on a policy of the business. For example, a business may have a policy not to be a “subprime” lender (e.g., to lend money to a borrower with a credit score below a predetermined limit). Therefore, the business may strive to not conduct any transactions which involve the business extending credit to a borrower with a credit score below a predetermined limit.

However, there may be exceptions to these policies. For example, if a particular borrower has a long relationship with the bank that is in good standing and the borrower has a large amount of assets with which the loan may be secured, then, because, in that particular case, the loan is much less risky, the bank may be inclined to make an exception to the policy. It is noted there may be exceptions made for other reasons as well.

Still, it would be desirable to avoid having too many exceptions to the policy in order to ensure that the purpose of the policy is not undermined. Hence, aspects of the disclosure relate to formulating, monitoring, managing exception rates of the policy limit. An example of an exception rate is the amount at which a business plans to originate loans which violate the policy limits. Further, an exception rate target may be the ideal amount of transactions that a business desires to conduct which violate the policy limit. For example, an exception rate target may be zero. A policy limit, or exception rate limit, may be the amount of transactions (which violate the policy limit) that a business may conduct before which the purpose and effect of policy limit is nullified, undermined or otherwise compromised.

With regard to the above described situation regarding subprime lending, a bank may have a policy that it will strive not to engage in lending money to a borrower with a credit score below a predetermined limit that would be considered subprime. While, the bank may make exceptions to this policy in some instances, the bank may create an exception rate limit of X % with regard to this aspect of the business (subprime lending). The exception rate limit may dictate that no more than X % of new originations can be from subprime lending. Alternatively, or additionally, the exception rate limit may dictate that no more than, X % of the bank's portfolio may be attributed to subprime lending. In this case, new originations must be limited based on the portfolio's current status to ensure that no more than X % of the banks portfolio is due to subprime lending. For example, if X % of the bank's current portfolio is already due to subprime lending, then no new originations attributable to subprime lending may be initiated.

The rationales behind the policies may be varied (e.g., a rational may be that a particular aspect of the business contains a high risk of loss, or a rational may be based solely on the business's experience in that aspect or field of the business), but regardless of the particular rationales behind the policies, by formulating, monitoring, managing and enforcing policy limits and exception rate targets and exception rate limits, such as described above, a business may effectively and efficiently manage (and limit) its credit risk.

It is noted that values for the above described exception rate target and the exception rate limit may be set as desired. For example, according to aspects of the disclosure, an exception rate target of a policy may be slightly more than 0% of business in that aspect of the business. However, it is noted that generally the exception rate limit may be kept relatively low in order to prevent the rationale for the policy from being undermined. Further, it is noted that the above described policy on subprime lending is merely illustrative and other policies may be used as desired.

Examples of other policy limits in which exception rate targets and exception rate limits may be used include: no new originations of business (and/or, no business in the portfolio) wherein the borrower has a FICO® score below a predetermined amount (e.g., 700); no new originations of business (and/or, no business in the portfolio) wherein the borrower is currently more than 60 days past due on any bureau trade with a balance of more than a predetermined amount (e.g., $2000); no new originations of business (and/or, no business in the portfolio) wherein the borrower has had a bankruptcy or unpaid charge-off with the bank, or any bankruptcy, repossession, foreclosure or unpaid charge-off with any lender wherein the event occurred within a predetermined amount of time (e.g., past 7 years).

Further examples of other policies in which exception rate targets and exception rate limits or policy limits may be used include: no new originations of business (and/or, no business in the portfolio) wherein the borrower has more than a predetermined amount (e.g., $50,000) in bankcard revolving debt; no new originations of business (and/or, no business in the portfolio) wherein the borrower has unsecured revolving utilization which exceeds a predetermined percentage (e.g., 80%); no new originations of business (and/or, no business in the portfolio) wherein current cardholders that are currently more than a predetermined amount of time (e.g., 60 days) delinquent with a balance more than a predetermined amount (e.g., more than $400); no new originations of business (and/or, no business in the portfolio) wherein the borrower has automated initial line assignments which exceed a predetermined amount (e.g., $13,500 in Franchise Pre-approved) and also exceeds a predetermined amount (e.g., $17,000) elsewhere.

Further examples of other policies in which exception rate targets and exception rate limits and policy limits may be used include: no new originations of business can be automatically approved if the borrower is unemployed; no new originations of business (and/or, no business in the portfolio) wherein the borrower is under a predetermined age (e.g., 18 years old) or under a predetermined age (e.g., 21 years old) and without a demonstrated ability to pay; no new originations of business (and/or, no business in the portfolio) wherein the borrower has more than a predetermined amount (e.g., 40%) in bankcard revolving debt to income; no new originations of business (and/or, no business in the portfolio) wherein the new account will cause the borrower to exceed more than a predetermined amount ($200,000) in the lender's bank card exposure.

Further examples of other policies in which exception rate targets and exception rate limits and policy limits may be used include: no new originations of business can be automatically approved if the borrower has more than predetermined amount of accounts (e.g., 3 accounts); no new originations of business (and/or, no business in the portfolio) for the borrower unless the borrower has income or a demonstrated ability to pay the loan. The above described examples of policies in which exception rate targets and exception rate limits, or policy limits, may be employed are merely illustrative and not meant to be limiting. Other policies and exception rate targets and exception rate limits, or policy limits, may be used as desired.

In order to achieve the business's exception rate targets, and exception rate limits, or policy limits, the business may monitor and adjust new originations to ensure that the policy limits are enforced. Additionally, or alternatively, other methods may be used to ensure that exception rate targets and exception rate limits, or policy limits, are enforced. For example, the business may conduct transactions, such as sales of current assets in order to ensure that that exception rate targets, and exception rate limits, or policy limits, are enforced. Hence, according to aspects of the disclosure, by formulating, monitoring, managing and enforcing of exception rate targets, and exception rate limits, or policy limits, a business may effectively and efficiently manage (and limit) its credit risk (e.g., by reducing exposure to certain high risk segments).

According to aspects of the disclosure, and as will be described in detail below, the exception rate target and exception rate limit, or policy limit, information may be monitored periodically or routinely (e.g., the exception rate limit, or policy limit, information may be monitored monthly, quarterly, for each new book of business, etc.). For example, as will be described in detail below, according to aspects of the disclosure, information related to new originations or the portfolio may be stored in one or more databases of the business. Further, according to aspects of the disclosure, the business may have one or more computer systems configured to extract from the database selective information regarding the new originations or the portfolio and compile such information for the review by the business (e.g., a risk management team). According to aspects of the disclosure, the one or more computer systems configured to extract such information from the one or more databases may be configured to automatically extract and compile such information (e.g., periodically as described above). Further, according to aspects of the disclosure, the one or more computer systems may be configured to automatically indicate if an exception rate limit, or policy limit, is breached or about to be breached. In this way, the business may effectively and efficiently realize the potential risk associated with the circumstance and, hence, take action to manage (and limit) its credit risk. For example, the business may alter their new originations, manage their current assets (e.g., sell current assets or acquire new assets), etc. to correct the new originations or the portfolio to meet the exception rate limit, or policy limit.

As discussed above, according to aspects of the disclosure, concentration limits may be one element that is monitored, managed and controlled in order to manage the credit risk associated with a business. According to aspects of the disclosure, concentration limits may be limits on the amount of business an organization may do with regard to a particular area or aspect of business. The rationale for imposing a concentration limit on a particular aspect of business may be to ensure that the business does not become overly invested, or concentrated, in one particular aspect of the business. For example, concentration limits may ensure appropriate diversification and protect the business from over-exposure to certain segments that could cause significant losses if an extreme condition occurred. This may be particularly useful if the particular aspect of the business contains a large amount of credit risk.

According to aspects of the disclosure, a concentration limit may be applied to a geographic region (e.g., a state with in the United States, or a region within a state). For example, a business may have wish to avoid becoming too concentrated (e.g., conducting too much of the entire business) in a particular geographic region in which defaults or other NCLs may be more likely to occur. Therefore, aspects of the disclosure relate to formulating, monitoring and managing concentration limits which limit the amount of business (e.g., new originations of credit products or an overall portfolio) that a business may do in a particular geographic area.

For example, if there is a high default rate on mortgages in a particular region, the bank may limit the amount of credit products (e.g., first mortgages) which are allowed to originates from that particular geographic area, so as not exceed the defined concentration limit for the portfolio. According to aspects of the disclosure, the concentration for the business in a particular area may be considered as a percentage of the business's portfolio balance in that geographic region divided by the business total portfolio balance.

With regard to the above described situation regarding concentration rates directed to geographic regions, a bank may have a limit (e.g., 40%) of its portfolio attributable to a particular geographic area. Further, the business will have a target that less than limit (e.g., 40%) of the business's portfolio is attributable to a particular geographic area. In this case, new originations must be limited based on the portfolio's current status to ensure that no more than the limit (e.g., 40%) of the bank's portfolio is attributable to a particular geographic area. For example, if that limit (e.g., 40%) of the bank's current portfolio is already attributable to a particular geographic area, then no new originations may be initiated in that particular geographic area.

It is noted that according to aspects of the disclosure, concentration limits are not limited to particular geographic areas and, instead, may apply to other aspects of a business as well. For example, concentration limits may be applied to high risk areas of business such as potential borrowers without credit history. For example, according to aspects of the disclosure, a business may have a concentration limit that no more than a predetermined amount or percentage (e.g., 7%) of the business's originations will be emerging credit (e.g., borrowers without credit history). Similarly, according to aspects of the disclosure, a business may have a concentration limit that no more than a predetermined amount or percentage (e.g., 7%) of the business's entire portfolio will be attributable to emerging credit (e.g., borrowers without credit history). Similarly, according to aspects of the disclosure, a business may have a concentration limit that no more than a predetermined amount or percentage (e.g., 7%) of the business's organic growth on a quarterly basis will be attributable to emerging credit (e.g., borrowers without credit history). It is noted that in contrast to the above described policy limits, which outline where a business establishes absolute limits on new credit originations or other business aspects, these concentration limits may manage more concrete limits that protect from overconcentration in various customer segments.

It is noted that according to aspects of the disclosure, just a business may have concentration limits, the bank may also have concentration goals which define objectives for the amount of business an organization may do with regard to a particularly area or aspect of business. The rationale for creating a concentration goal for a particular aspect of business may be to ensure that the business takes advantage of an aspect of the business (e.g., an aspect of the business with a small amount of credit risk).

For example, according to aspects of the disclosure, a business may have a concentration goal that at least a predetermined amount or percentage (e.g., 7%) of the business's originations will be borrowers with a FICO score above a predetermined number (e.g., 700). Similarly, according to aspects of the disclosure, a business may have a concentration goal that at least a predetermined amount or percentage (e.g., 7%) of the business's entire portfolio will be attributable to borrowers with a favorable credit history that is longer than a predetermined amount of time (e.g., 4 years). According to aspects of the disclosure, methods of managing credit risk may involve balancing concentration limits and concentration goals (e.g., by controlling new originations or controlling other transactions to ensure such limits or goals are achieved).

According to aspects of the disclosure, and as will be described in detail below, the concentration limit information may be monitored periodically or routinely (e.g., the concentration limit information may be monitored monthly, quarterly, for each new book of business, etc.). For example, as will be described in detail below, according to aspects of the disclosure, information related to new originations or the portfolio may be stored in one or more databases of the business. Further, according to aspects of the disclosure, the business may have one or more computer systems configured to extract from the database selective information regarding the new originations or the portfolio and compile such information (such as described above) for review by the business (e.g., a risk management team). According to aspects of the disclosure, the one or more computer systems configured to extract such information from the one or more databases may be configured to automatically extract and compile such information (e.g., periodically as described above). Further, according to aspects of the disclosure, the one or more computer systems may be configured to automatically indicate (such as described above) if a concentration limit is breached or about to be breached. In this way, the business may effectively and efficiently realize the potential risk associated with the circumstance and, hence, take action to manage (and limit) its credit risk. For example, the business may alter their new originations, manage their current assets (e.g., sell current assets or acquire new assets), etc. to correct the new originations or the portfolio to meet the concentration limit.

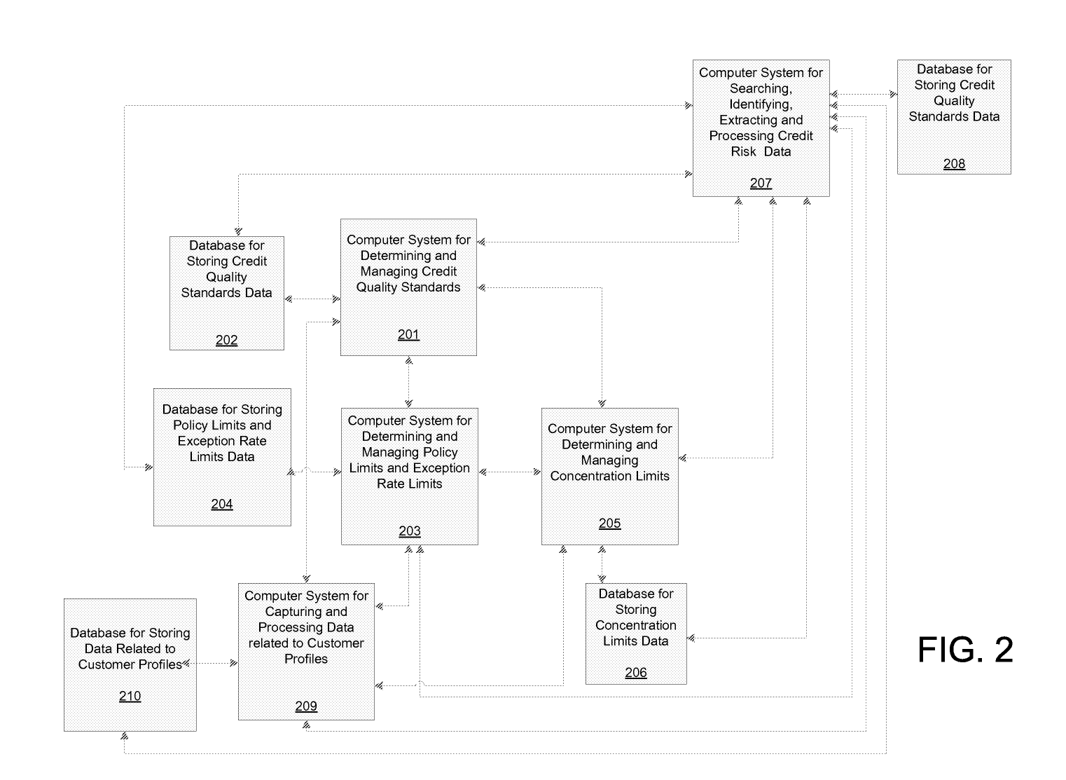

As discussed above, according to aspects of this disclosure, a business may have one or more computer systems that are used for capturing and processing data related to managing credit risk. FIG. 2 illustrates a block diagram of a computing environment 200 in which certain aspects of the present disclosure may be implemented. As seen in FIG. 2, a bank may have one or more computer systems 201 that are used for determining and managing credit quality standards. Further, computer system 201 may include a database 202 for storing data related to credit quality standards (or, alternatively, the computer systems in this disclosure may store the data described in the disclosure). Additionally, as seen in FIG. 2, a bank may have one or more computer systems 203 that are used for determining and managing policy limits and exception rate limits. Further, computer system 203 may include a database 204 for storing data related to policy limits and exception rate limits. Further, the bank may have one or more computer systems 205 for determining and managing concentration limits. Further, computer system 205 may include a database 206 for storing data related to concentration limits. Further, the bank may have one or more computer systems 207 for searching, identifying, extracting and processing credit risk data. Further, computer system 207 may include a database 208 for storing data related to credit risk data. Additionally, as seen in FIG. 2, the computer systems 201, 203, 205 and 207 may each be configured to transmit data to each other, and other computer systems or databases within the bank.

It is noted that the one or more computer systems 201, 203, 205 and 207 may be configured to capture and process data by receiving data from a variety of sources. For example, employees of the business may input data for use in determining and managing credit risk (e.g., data described above with regard to new originations, portfolios, credit quality standards, policy limits, exception rate targets and exception rate limits, concentration limits, concentration targets, concentration goals, etc.). Alternatively, or additionally, the computer systems 201, 203, 205 and 207 may be configured to extract such information for other data that is input into the computer environment such as from other computer systems within the business. For example, such computer systems 201, 203, 205 and 207 may be configured to extract and retrieve such data (e.g., data described above with regard to new originations, portfolios, credit quality standards, policy limits, exception rate targets and exception rate limits, concentration limits, concentration targets, concentration goals, etc.) from the previously created reports (e.g., previous monthly or quarterly report) or other documents, spreadsheets, data, etc.

According to aspects of this disclosure, a bank may have one or more computer systems 209 that are used for capturing and processing data related to the customers and creating customer profiles. For example, a bank may have one or more computer systems 209 that are used for capturing and processing data about current customers and their financial relationships with the bank, such as: customer name, address, telephone number, email address, age, credit score, income, debt, place of employment (and its contact information, such as address, telephone numbers, etc.), the type of financial relationship/account (e.g., a loan, insurance, etc.), term of the relationship (e.g., term of a loan, the time current customer has been with the bank, etc.), particular relevant financial amounts in the relationship (e.g., monthly payments, total debt, interest rate, etc.), routing numbers and account numbers (e.g., entered by the customer or transmitted from the databases wherein the routing numbers and account numbers may have been captured and stored), whether automatic payments are set up to receive funds from a second bank, etc. The computer systems 209 used for capturing and processing customer profile data, may be configured to allow customers to input such customer profile data (e.g., via a web based system) or allow bank employees to enter such customer profile data. Further, the computer systems 209 may include one or more databases 210 for storing the customer profile data. For example, if the customer or bank employee enters such customer profile data, then the customer profile data may be stored in a database 210 associated with the computer systems 209 used for capturing and processing customer profile data. Also, the computer systems 209 used for capturing and processing current customer profile may be configured to transmit the customer profile data (e.g., to other computer systems or databases within the bank).

As discussed above, according to one or more aspects of the disclosure, a bank may have one or more computer systems 207 that are configured to search for, indentify, extract and process data from the above described computer systems 201, 203, 205, 209 and their respective databases 202, 204, 206, 210. For example, the one or more computer systems 207 may search for, indentify, extract and process data from the databases which store CQ data, policy limit and exception rate data, concentration limit data and customer profile data. Further, the computer systems 207 may extract data from the CQ data, policy limit and exception rate data, concentration limit data and customer profile data and compile the data in a format specified by the user (e.g., a list or spreadsheet). Additionally, the extracted data may be processed further as desired by the user.

It is noted, that according to aspects of this disclosure, the computer systems 207 configured to search for, extract and process data may be configured so the user is able to specify which particular data the user wants to search for, identify, extract and process. For example, the user may specify that the CQ data is to be searched for, identified, extracted and processed. As another example, the user may specify that the concentration limit data is to be searched for, identified, extracted and processed.

Therefore, it is understood, that according to one or more aspects of this disclosure, the bank may employ the computer systems 207 to search for, indentify, extract and process data the bank already has (e.g., data from the one or more databases containing CQ data, policy limit and exception rate data, concentration limit data and customer profile data) in order to leverage such information to manage credit risk.

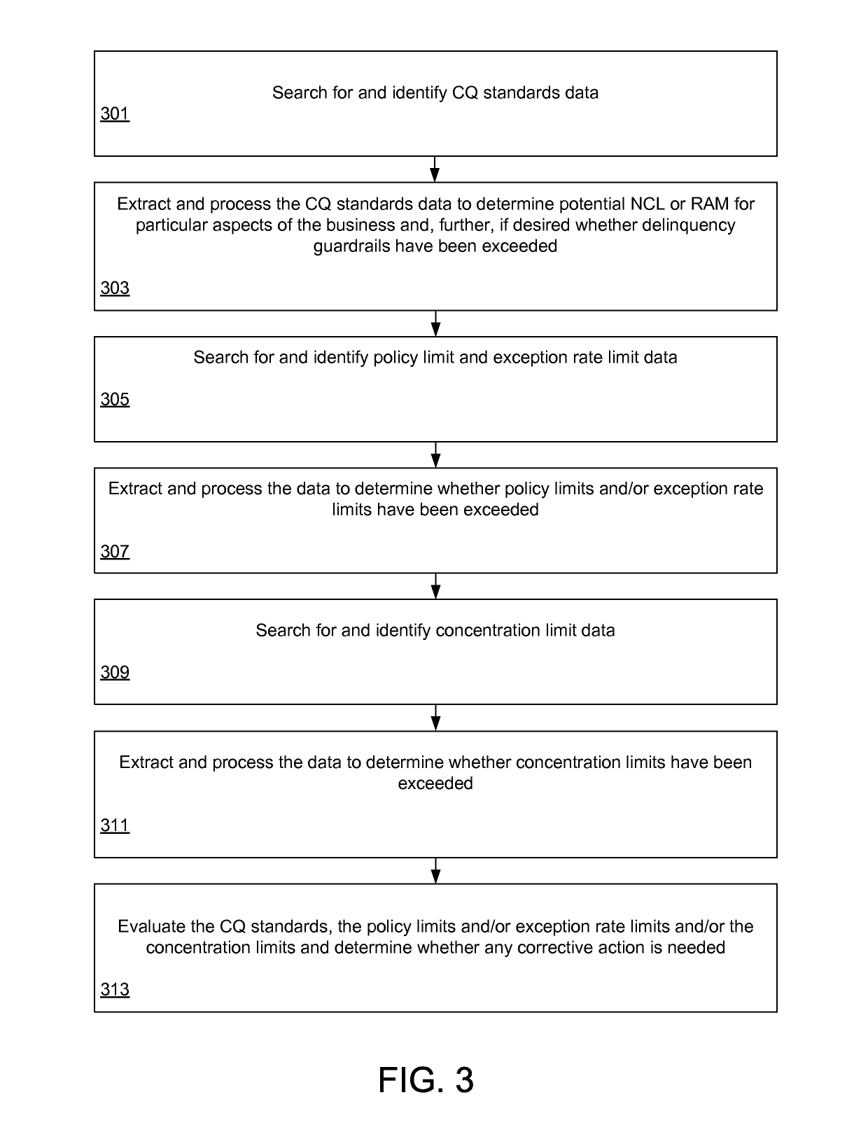

FIG. 3 illustrates a flow chart which describes an illustrative process for implementing the above described features for managing credit risk. As seen in FIG. 3, in step 301 the bank may search for and identify CQ standards data (e.g., the bank may use computers 209 to search CQ standards databases 202). Further, in step 303, once such information has been identified, the bank may (e.g., via one or more computers 209) extract and process the data, such as described above, to determine potential NCL or RAM for particular aspects of the business and, further, if desired, whether delinquency guardrails have been exceeded. Further, in step 305, the bank may search for and identify policy limit and exception rate limit data (e.g., the bank may use computers 209 to search policy limit and exception rate limit databases 204). Further, in step 307, once such information has been identified, the bank may (e.g., via one or more computers 209) extract and process the data, such as described above, to determine whether policy limits and/or exception rate limits have been exceeded. Further, in step 309, the bank may search for and identify concentration limit data (e.g., the bank may use computers 209 to search concentration limit database 206). Further, in step 311, once such information has been identified, the bank may (e.g., via one or more computers 209) extract and process the data, such as described above, to determine whether concentration limits have been exceeded. In step 313, the bank may evaluate the CQ standards, the policy limits and/or exception rate limits or the concentration limits and determine whether any corrective action is needed. Further, according to aspects of the disclosure, if any corrective action is needed, the bank may take appropriate corrective action such as described above.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. For example, any of the above described systems and methods or parts thereof may be combined with the other methods and systems or parts thereof described above. For example, the aspect of determining deposit amounts within branches of the second bank may be combined with any of the above described aspect of determining shared customers. It will also be appreciated and understood that modifications may be made without departing from the true spirit and scope of the present disclosure. The description is thus to be regarded as illustrative instead of restrictive on the present disclosure.

1. A computer configured to manage credit risk comprising:
a processor; and
memory storing computer executable instructions that, when executed, cause the computer to perform a method for managing credit risk, by:
electronically receiving data regarding one or more credit quality standards;
electronically receiving data regarding one or more policy limits or exception rate limits;
electronically receiving data regarding one or more concentration limits;
establishing one or more predetermined delinquency guardrails which relate to a maximum desired potential Net Credit Losses (NCL) or a minimum desired potential return for particular aspects of an organization,
based on the electronically received data, determining at least one of: whether the one or more predetermined delinquency guardrails have been exceeded, whether the policy limits or exception rate limits have been exceeded, and whether the concentration limits have been exceeded; and
managing a credit risk by taking a corrective action if one of the predetermined delinquency guardrails, policy limits, exception rate limits or concentration limits has been exceeded.

2. The computer according to claim 1, wherein the corrective action includes modifying an underwriting policy based on the electronically received data.

3. The computer according to claim 1, wherein the corrective action includes modifying one or more of the credit quality standards.

4. The computer according to claim 1, wherein the policy limits relate to at least one of: refraining from extending credit if a borrower's credit rating is below a predetermined score, refraining from extending credit if a borrower's age is below a predetermined age unless the borrower has demonstrated an ability to repay a loan; refraining from extending credit if a borrower's debt to income ratio is greater than a predetermined percentage, refraining from extending credit if a loan to value ratio is greater than a predetermined percentage, and refraining from extending credit if a borrower has declared bankruptcy within a predetermined amount of time.

5. The computer according to claim 1, wherein the concentration limits relate to refraining from extending credit wherein the extension of credit would cause a total amount of the organization's portfolio to be greater than a predetermined percentage in a particular geographic region.

6. The computer according to claim 1, wherein the concentration limits relate to refraining from extending credit wherein the extension of credit would cause a total amount of the organization's new originations for a given period of time to be greater than a predetermined percentage in a particular geographic region.

7. The computer according to claim 1, wherein the concentration limits relate to refraining from extending credit wherein the extension of credit would cause a total amount of the organization's portfolio to be greater than a predetermined percentage in a particular aspect of the organization's business including at least one of: an emerging credit sector, including borrowers with a length of credit history less than a predetermined amount of time and a credit sector including borrowers with a credit rating below a predetermined credit score.

8. A computer assisted method for managing credit risk comprising:
electronically receiving data regarding one or more credit quality standards;
electronically receiving data regarding one or more policy limits or exception rate limits;
electronically receiving data regarding one or more concentration limits;
using a computer to establish one or more predetermined delinquency guardrails which relate to a maximum desired potential Net Credit Losses (NCL) or a minimum desired potential return for particular aspects of an organization,
managing a credit risk by making a series of determinations about the electronically received data, wherein the determinations include at least one of:
determining whether the one or more predetermined delinquency guardrails have been exceeded,
determining whether the policy limits or exception rate limits have been exceeded, and
determining whether the concentration limits have been exceeded;
wherein managing a credit risk includes taking a corrective action if one of the predetermined delinquency guardrails, policy limits, exception rate limits or concentration limits has been exceeded,
wherein the determinations are stored in the computer.

9. The computer assisted method of claim 8, wherein the corrective action includes modifying an underwriting policy based on the electronically received data.

10. The computer assisted method of claim 8, wherein the corrective action includes modifying one or more of the credit quality standards.

11. The computer assisted method of claim 8, wherein the policy limits relate to at least one of: refraining from extending credit if a borrower's credit rating is below a predetermined score, refraining from extending credit if a borrower's age is below a predetermined age unless the borrower has demonstrated an ability to repay a loan;
refraining from extending credit if a borrower's debt to income ratio is greater than a predetermined percentage, refraining from extending credit if a loan to value ratio is greater than a predetermined percentage, and refraining from extending credit if a borrower has declared bankruptcy within a predetermined amount of time.

12. The computer assisted method of claim 8, wherein the concentration limits relate to refraining from extending credit wherein the extension of credit would cause a total amount of the organization's portfolio to be greater than a predetermined percentage in a particular geographic region.

13. The computer assisted method of claim 8, wherein the concentration limits relate to refraining from extending credit wherein the extension of credit would cause a total amount of the organization's new originations for a given period of time to be greater than a predetermined percentage in a particular geographic region.

14. The computer assisted method of claim 8, wherein the concentration limits relate to refraining from extending credit wherein the extension of credit would cause a total amount of the organization's portfolio to be greater than a predetermined percentage in a particular aspect of the organization's business including at least one of: an emerging credit sector including borrowers with a length of credit history less than a predetermined amount of time and a credit sector including borrowers with a credit rating below a predetermined credit score.

15. A method for managing credit risk comprising:
receiving data regarding one or more credit quality standards;
receiving data regarding one or more policy limits or exception rate limits;
receiving data regarding one or more concentration limits;
establishing one or more predetermined delinquency guardrails which relate to a maximum desired potential Net Credit Losses (NCL) or a minimum desired potential return for particular aspects of an organization; and
managing a credit risk by making a series of determinations about the received data, wherein the determinations include at least one of:
determining whether the one or more predetermined delinquency guardrails have been exceeded,
determining whether the policy limits or exception rate limits have been exceeded, and
determining whether the concentration limits have been exceeded;
wherein managing a credit risk includes taking a corrective action if one of the predetermined delinquency guardrails, policy limits, exception rate limits or concentration limits has been exceeded.

16. The method according to claim 15, wherein the corrective action includes modifying an underwriting policy based on the electronically received data.

17. The method according to claim 15, wherein the corrective action includes modifying one or more of the credit quality standards.

18. The method according to claim 15, wherein the policy limits relate to at least one of: refraining from extending credit if a borrower's credit rating is below a predetermined score, refraining from extending credit if a borrower's age is below a predetermined age unless the borrower has demonstrated an ability to repay a loan; refraining from extending credit if a borrower's debt to income ratio is greater than a predetermined percentage, refraining from extending credit if a loan to value ratio is greater than a predetermined percentage, and refraining from extending credit if a borrower has declared bankruptcy within a predetermined amount of time.

19. The method according to claim 15, wherein the concentration limits relate to refraining from extending credit wherein the extension of credit would cause a total amount of the organization's portfolio to be greater than a predetermined percentage in a particular geographic region or refraining from extending credit wherein the extension of credit would cause a total amount of the organization's new originations for a given period of time to be greater than a predetermined percentage in a particular geographic region.

20. The method according to claim 15, wherein the concentration limits relate to refraining from extending credit wherein the extension of credit would cause a total amount of the organization's portfolio to be greater than a predetermined percentage in a particular aspect of the organization's business including at least one of: an emerging credit sector, including borrowers with a length of credit history less than a predetermined amount of time and a credit sector including borrowers with a credit rating below a predetermined credit score.
